(19) United States
(12) Patent Application Publication
(10) Pub. No.: US 2025/0355285 A1
(43) Pub. Date: Nov. 20, 2025

(54) Optical Modulator

(71) Applicant: Nippon Telegraph and Telephone Corporation, Tokyo (JP)

(72) Inventors: Tatsuro Hiraki, Musashino-shi, Tokyo (JP); Shinji Matsuo, Musashino-shi, Tokyo (JP)

(21) Appl. No.: 18/871,720

(22) PCT Filed: Jun. 6, 2022
(86) PCT No.: PCT/JP2022/022767

§ 371 Date: Dec. 4, 2024

(51) Int. Cl. G02F 1/025

(52) U.S. Cl. CPC G02F 1/025; G02F 2203/50

(57) ABSTRACT

The optical modulator first includes a lower cladding layer formed on a substrate and a semiconductor layer formed of a group III-V compound semiconductor and disposed on the lower cladding layer. In the semiconductor layer, a phase modulation layer extending in a predetermined direction, and an n-type layer and a p-type layer formed in contact with the phase modulation layer with the phase modulation layer interposed therebetween in plan view are formed. In addition, the optical modulator includes an optical coupling layer that is stacked on the semiconductor layer separately from the semiconductor layer and extends along the phase modulation layer in a state of being optically couplable with the phase modulation layer.

### TECHNICAL FIELD

The present invention relates to an optical modulator.

### BACKGROUND ART

A technology of integrating a group III-V semiconductor on a Si optical waveguide circuit formed on a substrate having a large diameter is a key technology for realizing downsizing and cost reduction of a transceiver for optical communication including a laser. A device in which a semiconductor laser is stacked on a Si optical circuit using a technique of directly bonding a group III-V semiconductor material onto a Si substrate or the like has been realized. In recent years, the group III-V semiconductor on Si has attracted attention not only as a laser but also as a material for manufacturing a high-speed and highly efficient external modulator and optical receiver. In particular, an optical modulator manufactured using a layer of a thin film InP-based material bonded onto a Si substrate easily achieves both high modulation efficiency and high speed due to extremely small element capacitance and a high optical confinement factor.

A conventional optical modulator will be described with reference to FIG. 16 (Non Patent Literature 1). The optical modulator is formed on a substrate 301 made of silicon. A lower cladding layer 302 made of oxidized Si is formed on the substrate 301, and an n-type layer 303 and a p-type layer 304 are provided on the lower cladding layer 302. The n-type layer 303 and the p-type layer 304 are made of a group III-V compound semiconductor such as InP. The n-type layer 303 and the p-type layer 304 form a pn junction in a direction (horizontal direction) parallel to the plane of the substrate 301, and have a rib-type optical waveguide structure including a rib 307 in a formation region of the pn junction.

In this optical modulator, an n-type layer 303 and a p-type layer 304 made of an InP-based material having high phase modulation efficiency are embedded in an upper cladding layer 308 made of SiO₂ or the like, and strong optical confinement is realized by a large refractive index difference between the upper cladding layer 308 and the n-type layer 303 and the p-type layer 304. In addition, in order to improve optical confinement in the horizontal direction with respect to the substrate 301, a rib 307 is formed by etching a part of the n-type layer 303 and the p-type layer 304 to form a rib-type optical waveguide structure.

In this optical modulator, a phase of guided light can be modulated by doping a donor to form the n-type layer 303, doping an acceptor to form the p-type layer 304, and applying an electric field in a horizontal direction to the substrate 301 via an electrode 305 and an electrode 306. In this optical modulator, since the rib-type optical waveguide is formed by etching of the semiconductor layer, an epitaxial growth process after direct bonding required for other optical modulators (Non Patent Literature 2) is unnecessary. Therefore, it is suitable for reducing the manufacturing cost.

### CITATION LIST

### Non Patent Literature

Non Patent Literature 1: Y. Ikku et al., “Low-driving-current InGaAsP photonic-wire optical switches using III-V CMOS photonics platform”, Optics Express, Vol. 20, No. 26, pp. B357-B364, 2012.
Non Patent Literature 2: T. Hiraki et al., “Integration of a high-efficiency Mach-Zehnder modulator with a DFB laser using membrane InP-based devices on a Si photonics platform”, Optics Express, Vol. 29, No. 2, pp. 2431-2441, 2021.

### SUMMARY OF INVENTION

### Technical Problem

However, the conventional optical modulator described above forms a rib-type optical waveguide structure by etching a layer of a group III-V compound semiconductor. For this reason, the optical confinement factor, the phase of the guided light, and the optical loss, which correspond to the error in the etching amount at the time of processing and contribute to the size of the step of the rib portion, sensitively change. However, it is difficult to control the amount of etching with high accuracy over the entire surface of a large-diameter wafer (substrate). As described above, in the conventional technique, in-wafer plane variation element performance has been a problem.

The present invention has been made to solve the above problems, and an object of the present invention is to suppress in-wafer plane variation in element performance of an optical modulator.

### Solution to Problem

An optical modulator according to the present invention includes a cladding layer formed on a substrate; a semiconductor layer formed of a group III-V compound semiconductor and disposed on the cladding layer; a phase modulation layer extending in a predetermined direction in the semiconductor layer; an n-type layer and a p-type layer formed in the semiconductor layer, the n-type layer and the p-type layer being in contact with the phase modulation layer with the phase modulation layer interposed therebetween in plan view; an optical coupling layer that is stacked on the semiconductor layer separately from the semiconductor layer and extends along the phase modulation layer in a state of being optically couplable with the phase modulation layer; an n-type electrode connected to the n-type layer; and a p-type electrode connected to the p-type layer.

### Advantageous Effects of Invention

As described above, according to the present invention, since the optical coupling layer is provided separately from the semiconductor layer on which the phase modulation layer is formed, it is possible to suppress the in-wafer plane variation in element performance of the optical modulator.

### BRIEF DESCRIPTION OF DRAWINGS

FIG. 1 is a cross-sectional view illustrating a configuration of an optical modulator according to a first embodiment of the present invention.

FIG. 2 is a characteristics diagram illustrating dependency of an optical confinement factor in a phase modulation layer 131 on a width of an optical coupling layer 104 in each of thicknesses 100 nm, 150 nm, 200 nm, and 250 nm of a semiconductor layer 103 (phase modulation layer 131).

FIG. 3 is a characteristics diagram illustrating a relationship between the optical confinement factor in the phase modulation layer 131 and the width of the optical coupling layer 104 when the thickness of the semiconductor layer 103 is 150 nm and the width of the phase modulation layer 131 is 400 nm, 600 nm, or 800 nm.

FIG. 4 is a cross-sectional view illustrating a configuration of another optical modulator according to the first embodiment of the present invention.

FIG. 5 is a characteristics diagram illustrating a relationship between the optical confinement factor in the p-type layer 133, the optical confinement factor in the phase modulation layer 131, and the shift amount of the optical coupling layer 104 under the condition that the thickness of the semiconductor layer 103 is 150 nm, the width of the optical coupling layer 104 is 800 nm, and the width of the phase modulation layer 131 is 400 nm.

FIG. 6 is a cross-sectional view illustrating a configuration of another optical modulator according to the first embodiment of the present invention.

FIG. 7A is a plan view illustrating a partial configuration of optical connection between an optical modulator 100 and a passive optical waveguide 150.

FIG. 7B is a cross-sectional view illustrating a partial configuration of the optical connection between the optical modulator 100 and the passive optical waveguide 150.

FIG. 7C is a cross-sectional view illustrating a partial configuration of the optical connection between the optical modulator 100 and the passive optical waveguide 150.

FIG. 8 is a characteristics diagram illustrating a change in coupling efficiency between the optical modulator 100 and the passive optical waveguide 150 with respect to a change in a core width of a connection portion of a tapered core 152 to the optical modulator 100.

FIG. 9 is a cross-sectional view illustrating a configuration of an optical modulator according to a second embodiment of the present invention.

FIG. 10 is a characteristics diagram illustrating width (core width) dependency of an optical confinement factor in the phase modulation layer 131 in widths 400 nm, 600 nm, and 800 nm of the phase modulation layer 131 on a plane perpendicular to a waveguide direction of the optical coupling layer 104a.

FIG. 11 is a cross-sectional view illustrating a configuration of another optical modulator according to the second embodiment of the present invention.

FIG. 12 is a characteristics diagram illustrating the relationship between the optical confinement factor in the p-type layer 133, the optical confinement factor in the phase modulation layer 131, and the shift amount of the optical coupling layer 104a under the condition that the thickness of the semiconductor layer 103 is 150 nm, the width of the optical coupling layer 104a is 300 nm, and the width of the phase modulation layer 131 is 600 nm.

FIG. 13A is a plan view illustrating a partial configuration of optical connection between an optical modulator 100a and a passive optical waveguide 150a.

FIG. 13B is a cross-sectional view illustrating a partial configuration of the optical connection between the optical modulator 100a and the passive optical waveguide 150a.

FIG. 13C is a cross-sectional view illustrating a partial configuration of the optical connection between the optical modulator 100a and the passive optical waveguide 150a.

FIG. 13D is a cross-sectional view illustrating a partial configuration of the optical connection between the optical modulator 100a and the passive optical waveguide 150a.

FIG. 14 is a characteristics diagram illustrating a relationship between coupling efficiency between passive optical waveguide 150a and optical modulator 100a and a core width of a tapered core 152a at a connection end of the passive optical waveguide 150a with the optical modulator 100a.

FIG. 15A is a plan view illustrating a partial configuration of optical connection between the optical modulator 100a and a passive optical waveguide 150b.

FIG. 15B is a cross-sectional view illustrating a partial configuration of the optical connection between the optical modulator 100a and the passive optical waveguide 150b.

FIG. 15C is a cross-sectional view illustrating a partial configuration of the optical connection between the optical modulator 100a and the passive optical waveguide 150b.

FIG. 16 is a cross-sectional view illustrating a configuration of a conventional optical modulator.

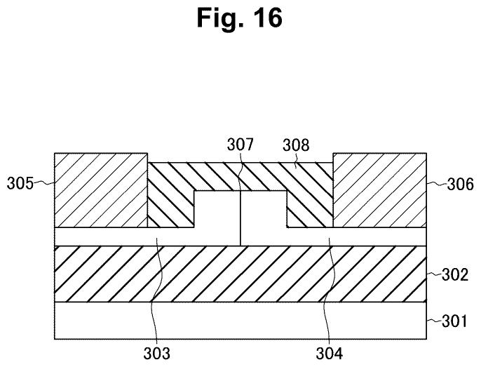

### DESCRIPTION OF EMBODIMENTS

The following is a description of optical modulators according to embodiments of the present invention.

### First Embodiment

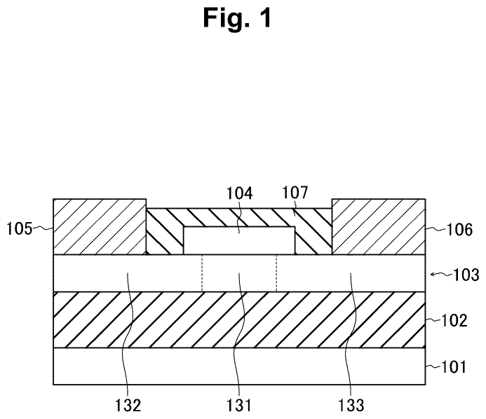

First, an optical modulator according to a first embodiment of the present invention will be described with reference to FIG. 1. The optical modulator first includes a lower cladding layer 102 formed on a substrate 101 and a semiconductor layer 103 formed of a group III-V compound semiconductor and disposed on the lower cladding layer 102. In the semiconductor layer 103, a phase modulation layer 131 extending in a predetermined direction, and an n-type layer 132 and a p-type layer 133 formed in contact with the phase modulation layer 131 with the phase modulation layer 131 interposed therebetween in plan view are formed. An n-type electrode 105 is electrically connected to the n-type layer 132, and a p-type electrode 106 is electrically connected to the p-type layer 133.

In addition, the optical modulator includes an optical coupling layer 104 that is stacked on the semiconductor layer 103 separately from the semiconductor layer 103 and extends along the phase modulation layer 131 in a state of being optically couplable with the phase modulation layer 131. In the first embodiment, the optical coupling layer 104 is formed above the semiconductor layer 103 (phase modulation layer 131) as viewed from the substrate 101 side. In addition, in the first embodiment, the optical coupling layer 104 is formed in contact with the semiconductor layer 103 (phase modulation layer 131), and the upper cladding layer 107 is formed in the semiconductor layer 103 so as to cover the optical coupling layer 104. The semiconductor layer 103 and the optical coupling layer 104 constitute a rib-type optical waveguide structure.

The substrate 101 is a silicon substrate. The lower cladding layer 102 can be made of, for example, SiO₂. The semiconductor layer 103 can be made of, for example, a quaternary InP-based material such as InGaAsP or InGaAlAs. The semiconductor layer 103 can be a bulk layer and can be a layer of a multiple quantum well structure.

The optical coupling layer 104 is made of a material different from that of the semiconductor layer 103. The optical coupling layer 104 can be made of, for example, silicon nitride. It is known that the etching rate of silicon nitride has a high selectivity to that of an InP-based material. The optical coupling layer 104 made of silicon nitride can have a thickness of 200 nm. Note that a refractive index of the optical coupling layer 104 made of silicon nitride is 1.95. The semiconductor layer 103 can be made of an InP-based material having a refractive index of 3.4.

In addition, the phase modulation layer 131 formed in the semiconductor layer 103 may be a non-doped i-type layer and may have a width of 400 nm. By applying a reverse bias voltage to the phase modulation layer 131 as the i-type layer by the n-type layer 132 and the p-type layer 133, an electric field is applied to the phase modulation layer 131, and the phase of the guided light can be modulated by the Franz-Keldysh effect.

According to the above-described embodiment, after a layer of a group III-V compound semiconductor is bonded to the substrate 101 (lower cladding layer 102) to form the semiconductor layer 103, the phase modulator structure can be manufactured without using any of epitaxial growth and dry etching for the semiconductor layer 103. Therefore, it is possible to suppress the in-wafer plane variation in element performance due to processing such as epitaxial growth and dry etching.

By forming the optical coupling layer 104 from a material capable of obtaining a selectivity of a high dry etching rate with respect to the semiconductor layer 103, an amount of over-etching of the underlying semiconductor layer 103 at the time of processing the optical coupling layer 104 is extremely reduced, and the rib-type optical waveguide structure is controlled with high accuracy by the thickness of the optical coupling layer 104. Therefore, it is possible to suppress performance variation due to variation in the processing amount of the semiconductor layer due to the InP-based material, which has been a problem in the conventional element. The optical coupling layer 104 is desirably made of, for example, silicon nitride or Si having a relatively high refractive index and small optical loss. In the optical waveguide optical mode, since the light intensity is concentrated on the semiconductor layer 103 immediately below the optical coupling layer 104, a region thereof is set as the phase modulation layer 131. When the phase modulation layer 131 is non-doped or n-type, a p-i-n diode or p-n diode structure is formed, and an electric field can be applied to the phase modulation region.

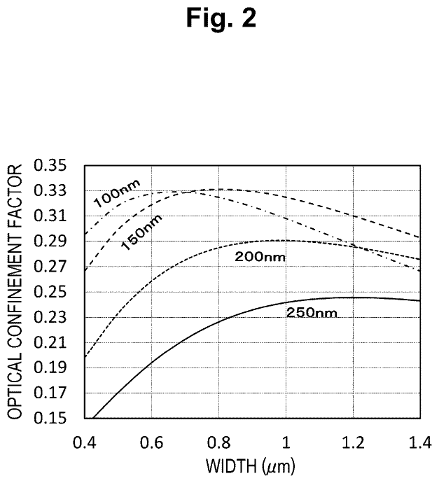

In addition, it is desirable to design the width of the optical coupling layer 104 such that the overlap between the phase modulation layer 131 and the guided light mode intensity distribution becomes large with respect to the thickness of the semiconductor layer 103. FIG. 2 illustrates the dependency of the optical confinement factor in the phase modulation layer 131 on the width of the optical coupling layer 104 in each of the thicknesses 100 nm, 150 nm, 200 nm, and 250 nm of the semiconductor layer 103 (phase modulation layer 131). As illustrated in FIG. 2, it can be seen that there is a width of the optical coupling layer 104 that maximizes optical confinement for each InP-based material film thickness. For example, under the condition that the thickness of the semiconductor layer 103 is 150 nm, a substantially maximum optical confinement factor can be obtained by setting the width of the optical coupling layer 104 to about 800 nm.

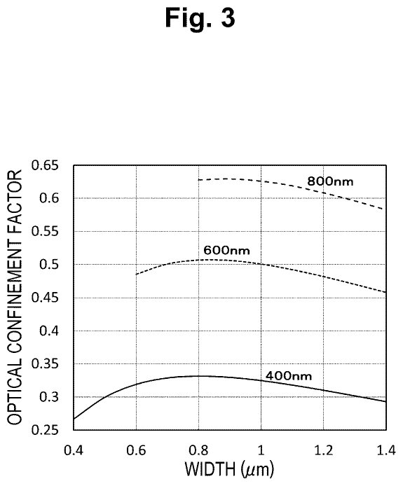

FIG. 3 illustrates a relationship between the optical confinement factor in the phase modulation layer 131 and the width of the optical coupling layer 104 when the thickness of the semiconductor layer 103 is 150 nm and the width of the phase modulation layer 131 is 400 nm, 600 nm, or 800 nm. The wider the width of the phase modulation layer 131, the larger the optical confinement factor. In this structure, it can be seen that the maximum optical confinement factors are found at approximately 800 nm width of the optical coupling layer 104 in any of the widths of the phase modulation layer 131.

In this structure, since optical confinement in the horizontal direction is relatively weak with respect to the plane of the substrate 101, the overlap between the guided light intensity distribution and the doped region becomes relatively large. In the semiconductor layer 103, the optical loss of the n-type layer 132 is very small, but since the p-type layer 133 has an extremely large optical loss, it is important to suppress light leakage to the p-type layer 133.

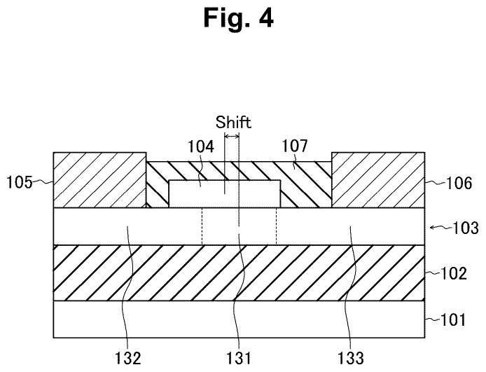

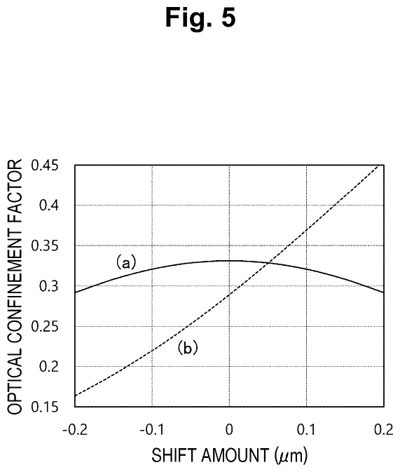

The above-described suppression of light leakage to the p-type layer 133 can be realized by shifting the center of the optical coupling layer 104 toward the n-type layer 132 as illustrated in FIG. 4. The central axis in the extending direction of the phase modulation layer 131 and the central axis in the extending direction of the optical coupling layer 104 are shifted toward the n-type layer 132 in a direction parallel to the plane of the substrate 101 and perpendicular to the extending direction. FIG. 5 illustrates the relationship between the optical confinement factor in the p-type layer 133, the optical confinement factor in the phase modulation layer 131, and the shift amount of the optical coupling layer 104 under the condition that the thickness of the semiconductor layer 103 is 150 nm, the width of the optical coupling layer 104 is 800 nm, and the width of the phase modulation layer 131 is 400 nm. Here, it means that when the shift amount is negative, the center of the optical coupling layer 104 is shifted toward the n-type layer 132 side.

It can be seen that the optical confinement factor in the p-type layer 133 is significantly reduced by shifting the position of the optical coupling layer 104 to the n-type layer 132 side. On the other hand, the change in the optical confinement factor in the phase modulation layer 131 is small, and the high optical confinement factor in the phase modulation layer 131 is maintained even if the shift amount is large. As a result, it can be seen that a low-loss and high-efficiency optical modulator is obtained by shifting the position of the optical coupling layer 104.

Next, manufacturing of the optical modulator will be briefly described. First, a thin film of an InP-based material is bonded to the lower cladding layer 102 on the substrate 101 to form the semiconductor layer 103. Next, the n-type layer 132 and the p-type layer 133 are formed at desired positions of the semiconductor layer 103 by an ion implantation method, a thermal diffusion method, or the like. The phase modulation layer 131 is formed between the formed n-type layer 132 and the p-type layer 133.

Next, a silicon nitride film is formed in the semiconductor layer 103 by depositing silicon nitride, and the formed silicon nitride film is patterned by a known lithography technique and etching technique to form the optical coupling layer 104. According to the well-known dry etching, in the etching processing of the silicon nitride film, the over-etching amount of the underlying semiconductor layer 103 is extremely small. Thereafter, the n-type electrode 105 and the p-type electrode 106 to be ohmic-connected are formed on the n-type layer 132 and the p-type layer 133. In addition, the upper cladding layer 107 is formed.

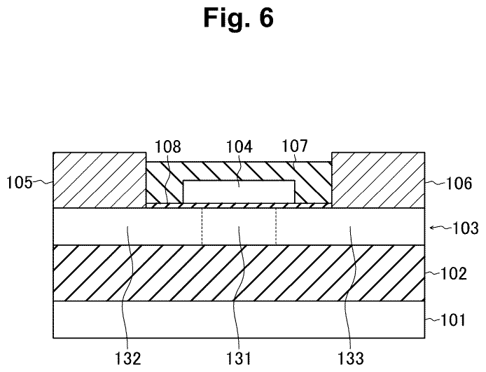

Meanwhile, as illustrated in FIG. 6, it is also possible to form an intermediate layer 108 serving as a passivation layer or an adhesion layer on the semiconductor layer 103 (phase modulation layer 131) and form the optical coupling layer 104 via the intermediate layer 108. The intermediate layer 108 can be made of, for example, SiO₂, Al₂O₃, or the like. The intermediate layer 108 can have a thickness in a range in which optical coupling between the semiconductor layer 103 and the optical coupling layer 104 is possible.

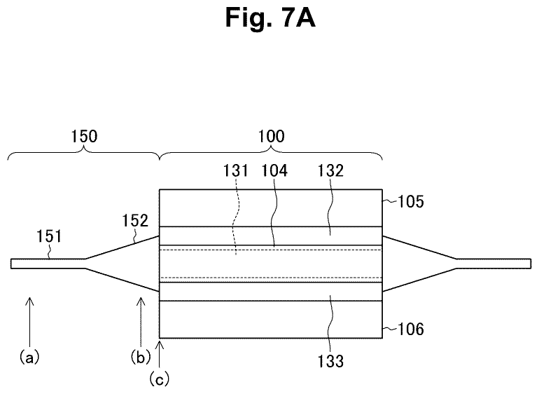

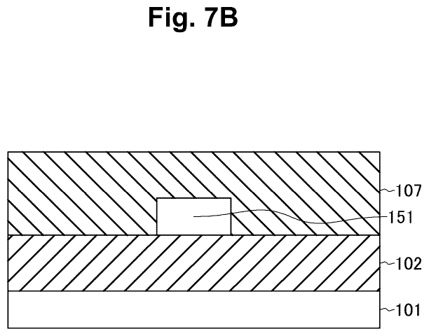

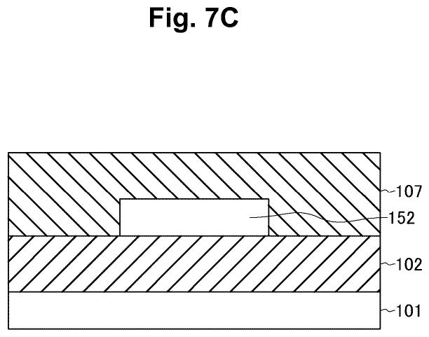

Next, optical connection between the optical modulator and the passive optical waveguide will be described. As illustrated in FIGS. 7A, 7B, and 7C, passive optical waveguide 150 can be optically connected to optical modulator 100 according to the first embodiment. FIG. 7B illustrates a cross section perpendicular to the waveguide direction at a position (a) in FIG. 7A, and FIG. 7C illustrates a cross section perpendicular to the waveguide direction at a position (b) in FIG. 7A. A cross section perpendicular to the waveguide direction at a position (c) in FIG. 7A is as illustrated in FIG. 1.

The passive optical waveguide 150 includes a thin wire core 151 having a core width satisfying a single mode condition and a tapered core 152 for converting a mode. The tapered core 152 gradually increases in width from the thin wire core 151 to the optical modulator 100. The thin wire core 151 and the tapered core 152 can be made of the same group III-V compound semiconductor as the semiconductor layer 103. The tapered core 152 and the thin wire core 151 can be formed continuously with the semiconductor layer 103 (phase modulation layer 131). For example, the thin wire core 151 and the tapered core 152 can be formed by patterning the semiconductor layer 103 formed over a region to be the passive optical waveguide 150.

Since the InP-based material constituting the semiconductor layer 103 is designed so that an absorption edge wavelength is sufficiently shorter than the guided light wavelength, the non-doped InP-based material can be a core material of a low-loss optical waveguide. The passive optical waveguide 150 is coupled to the rib-type optical waveguide by the semiconductor layer 103 and the optical coupling layer 104 of the optical modulator 100 in a portion (see FIG. 7C) where the core width is widened by the tapered core 152. Since a guided light mode light intensity in the optical modulator 100 is substantially confined in the semiconductor layer 103, it is possible to perform highly efficient coupling with the tapered core 152.

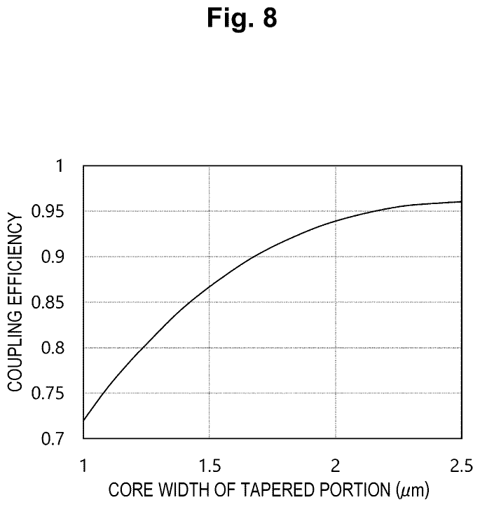

FIG. 8 illustrates a change in coupling efficiency between the optical modulator 100 and the passive optical waveguide 150 with respect to a change in the core width of a connection portion of the tapered core 152 with the optical modulator 100. The thickness of the semiconductor layer 103 is set to 150 nm, the thickness of the optical coupling layer 104 is set to 800 nm, and the width of the phase modulation layer 131 is set to 400 nm. When the core width is about 2.2 μm or more, the coupling efficiency tends to be substantially saturated, and a high coupling efficiency of about 95% can be obtained.

### Second Embodiment

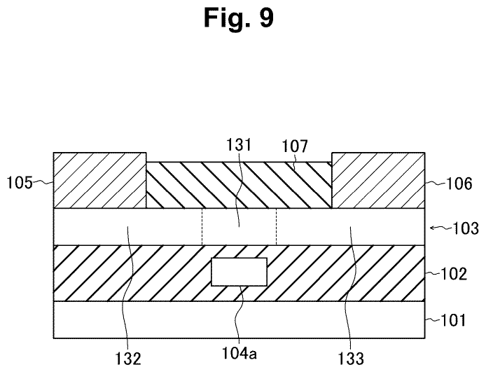

Next, an optical modulator according to a second embodiment of the present invention will be described with reference to FIG. 9. The optical modulator first includes a lower cladding layer 102 formed on a substrate 101 and a semiconductor layer 103 formed of a group III-V compound semiconductor and disposed on the lower cladding layer 102. In the semiconductor layer 103, a phase modulation layer 131 extending in a predetermined direction, and an n-type layer 132 and a p-type layer 133 formed in contact with the phase modulation layer 131 with the phase modulation layer 131 interposed therebetween in plan view are formed. An n-type electrode 105 is electrically connected to the n-type layer 132, and a p-type electrode 106 is electrically connected to the p-type layer 133.

In addition, the optical modulator includes an optical coupling layer 104a that is stacked on the semiconductor layer 103 separately from the semiconductor layer 103 and extends along the phase modulation layer 131 in a state of being optically couplable with the phase modulation layer 131. In the second embodiment, the optical coupling layer 104a is formed below the semiconductor layer 103 (phase modulation layer 131) as viewed from the substrate 101 side. In the second embodiment, the optical coupling layer 104a is embedded in the lower cladding layer 102. The optical coupling layer 104a can be disposed apart from the semiconductor layer 103 (phase modulation layer 131) and can be disposed in contact with the semiconductor layer 103 (phase modulation layer 131). In the optical coupling layer 104a, it is important to design the width of the optical coupling layer 104a so that optical confinement in the phase modulation layer 131 is maximized.

The optical coupling layer 104a is made of a material different from that of the semiconductor layer 103. The optical coupling layer 104a can be made of, for example, single crystal silicon (Si).

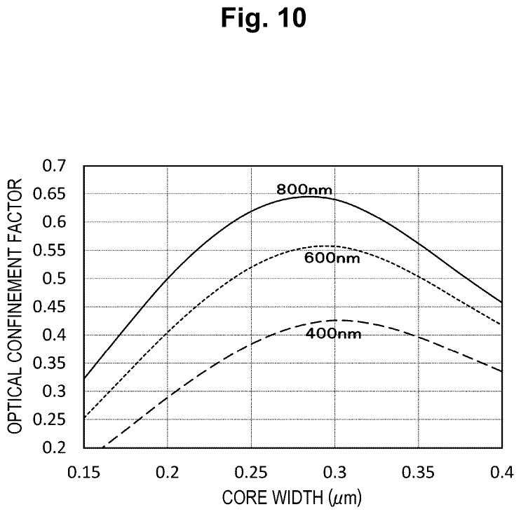

FIG. 10 illustrates width (core width) dependency of the optical confinement factor in the phase modulation layer 131 at widths 400 nm, 600 nm, and 800 nm of the phase modulation layer 131 on a plane perpendicular to the waveguide direction of the optical coupling layer 104a. The thickness of the semiconductor layer 103 is set to 150 nm, and the thickness of the optical coupling layer 104a made of silicon is set to 220 nm. In addition, the distance between the lower surface of the semiconductor layer 103 and the upper surface of the optical coupling layer 104a is set to 50 nm. It can be seen that when the core width of the optical coupling layer 104a is about 280 to 300 nm, a substantially maximum optical confinement factor can be obtained.

In addition, also in the optical modulator according to the second embodiment, similarly to the first embodiment, since optical confinement in the horizontal direction is relatively weak with respect to the plane of the substrate 101, the overlap between the guided light intensity distribution and the doped region becomes relatively large. Therefore, it is important to suppress light leakage to the p-type layer 133.

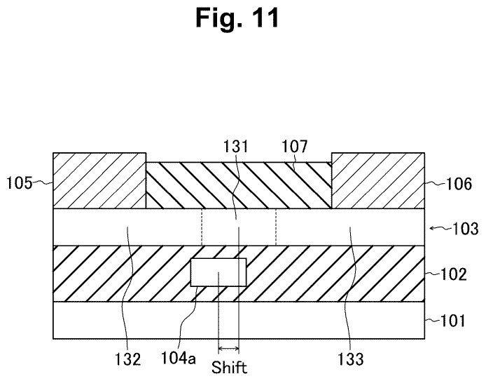

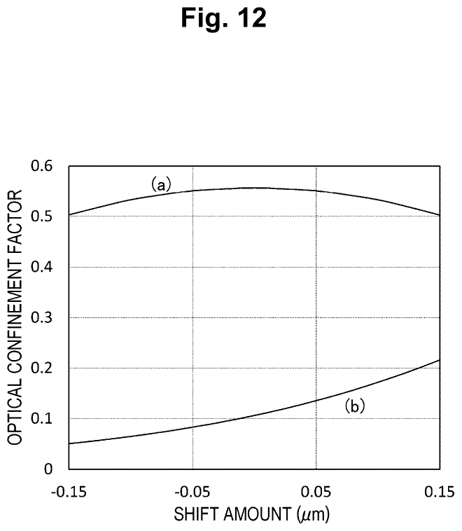

The above-described suppression of light leakage to the p-type layer 133 can be realized by shifting the center of the optical coupling layer 104a toward the n-type layer 132 as illustrated in FIG. 11. FIG. 12 illustrates the relationship between the optical confinement factor in the p-type layer 133, the optical confinement factor in the phase modulation layer 131, and the shift amount of the optical coupling layer 104a under the condition that the thickness of the semiconductor layer 103 is 150 nm, the width of the optical coupling layer 104a is 300 nm, and the width of the phase modulation layer 131 is 600 nm. Here, it means that when the shift amount is negative, the center of the optical coupling layer 104a is shifted toward the n-type layer 132 side.

It can be seen that by shifting the position of the optical coupling layer 104a toward the n-type layer 132, the optical confinement factor in the p-type layer 133 is significantly reduced. On the other hand, the change in the optical confinement factor in the phase modulation layer 131 is small, and the high optical confinement factor in the phase modulation layer 131 is maintained even if the shift amount is large. As a result, it can be seen that a low-loss and high-efficiency optical modulator is obtained by shifting the position of the optical coupling layer 104a.

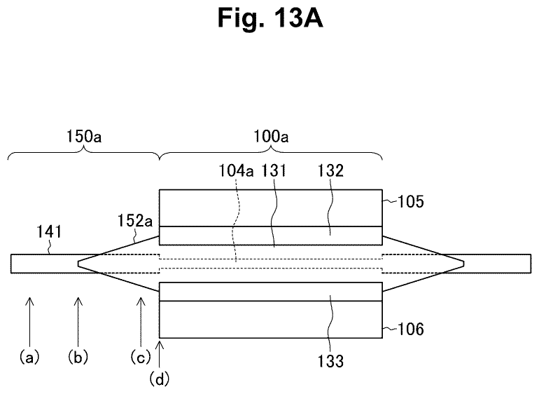

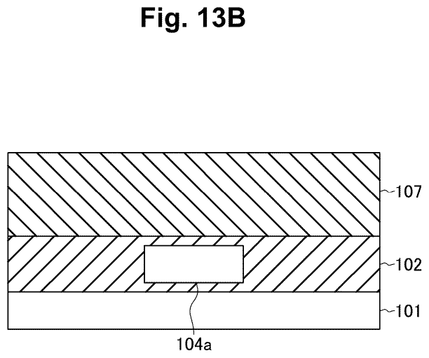

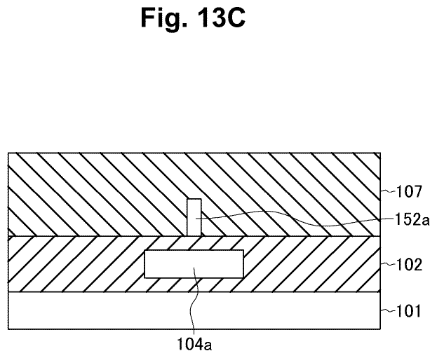

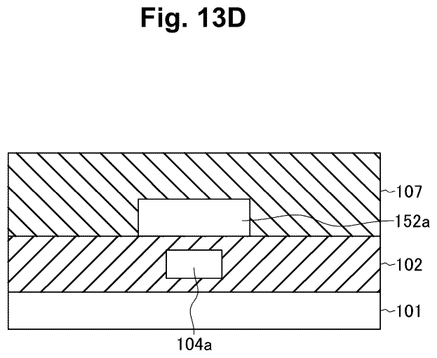

Next, optical connection between the optical modulator and the passive optical waveguide will be described. As illustrated in FIGS. 13A, 13B, 13C, and 13D, passive optical waveguide 150a can be optically connected to optical modulator 100a according to the second embodiment. FIG. 13B illustrates a cross section perpendicular to the waveguide direction at a position (a) in FIG. 13A, FIG. 13C illustrates a cross section perpendicular to the waveguide direction at a position (b) in FIG. 13A, and FIG. 13D illustrates a cross section perpendicular to the waveguide direction at a position (c) in FIG. 13A. A cross section perpendicular to the waveguide direction at a position (d) in FIG. 13A is as illustrated in FIG. 9.

The passive optical waveguide 150a includes a thin wire core 141 having a core width satisfying the single mode condition and a tapered core 152a for converting the mode. The thin wire core 141 is formed continuously with the optical coupling layer 104a and is made of silicon. The thin wire core 141 can have a thickness of 220 nm and a core width of 400 to 500 nm, for example. The optical coupling layer 104a continuously formed on the thin wire core 141 can have a core width of 300 nm.

The tapered core 152a gradually increases in width toward the optical modulator 100a from a position away from the optical modulator 100a. The tapered core 152a can have a width of a distal end farthest from the optical modulator 100a of 100 nm or less. The tapered core 152a can be made of the same group III-V compound semiconductor as the semiconductor layer 103. The tapered core 152a can be formed continuously with the semiconductor layer 103 (phase modulation layer 131). For example, the tapered core 152a can be formed by patterning the semiconductor layer 103 formed over a region to be the passive optical waveguide 150a.

In the position (b) of FIG. 13A, the light (signal light) guided in the optical waveguide by the thin wire core 141 is coupled to the distal end of the tapered core 152a, and in the position (c), the mode is expanded to a width enabling highly efficient coupling with the optical modulator 100a, and the light is coupled in the position (d).

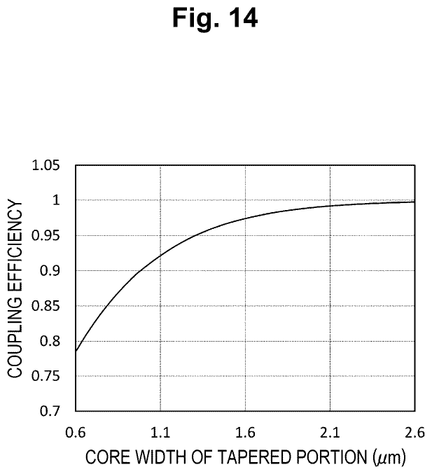

FIG. 14 illustrates a relationship between the coupling efficiency between passive optical waveguide 150a and optical modulator 100a and the core width of the tapered core 152a at a connection end of the passive optical waveguide 150a with optical modulator 100a. It can be seen that by widening the tapered core 152a from the distal end width of 100 nm to the connection end width of about 2.6 μm, coupling efficiency of almost 100% (coupling efficiency of 1) with the optical modulator 100a can be obtained.

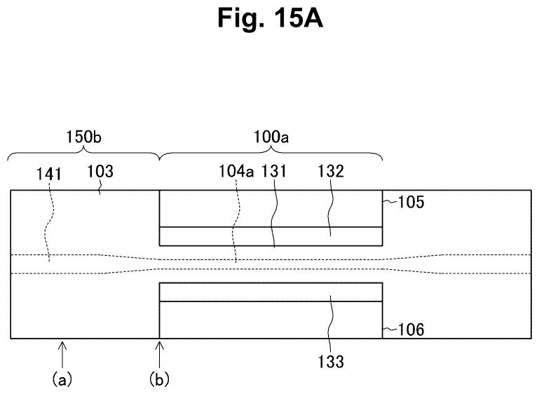

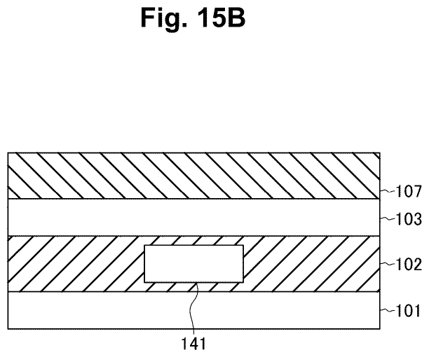

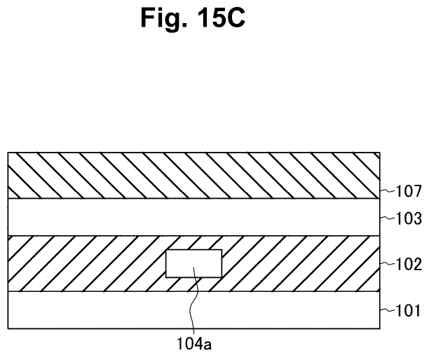

As illustrated in FIGS. 15A, 15B, and 15C, the semiconductor layer 103 formed over a region of a passive optical waveguide 150b may be left without being patterned, and the thin wire core 141 may be disposed below the semiconductor layer. In this case, at the connection portion between the passive optical waveguide 150b and the optical modulator 100a, the core width changes (decreases) from the continuously formed thin wire core 141 to the optical coupling layer 104a, and the passive optical waveguide 150b in which the optical confinement to the thin wire core 141 is strengthened is obtained.

Here, in the above-described embodiment, the phase modulation layer has been described as non-doped (i-type), but the phase modulation layer may be n-type doped with a donor. The donor has a relatively small absorption coefficient, but can perform significant phase modulation with free carriers, and thus is suitable for high efficiency. However, it is desirable that the donor introduced into the phase modulation layer has a carrier density lower than that of the n-type layer in which the electrode is formed from the viewpoint of reducing the loss.

Furthermore, the optical coupling layer 104 is not limited to silicon nitride, and can be made of amorphous silicon, for example. Furthermore, the optical coupling layer 104a is not limited to silicon, and can be made of silicon nitride. The silicon nitride does not need to have a stoichiometric composition (Si₃N₄), and silicon nitride having a composition ratio of silicon and nitrogen to have a target refractive index can be used.

As described above, according to the present invention, since the optical coupling layer is provided separately from the semiconductor layer on which the phase modulation layer is formed, it is possible to suppress the in-wafer plane variation in element performance of the optical modulator.

Some or all of the above embodiments are also described as the following supplementary notes, but are not limited to the following.

### [Supplementary Note 1]

An optical modulator including:
a cladding layer formed on a substrate;
a semiconductor layer formed of a group III-V compound semiconductor and disposed on the cladding layer;
a phase modulation layer extending in a predetermined direction in the semiconductor layer;
an n-type layer and a p-type layer formed in the semiconductor layer, the n-type layer and the p-type layer being in contact with the phase modulation layer with the phase modulation layer interposed therebetween in plan view;
an optical coupling layer that is stacked on the semiconductor layer separately from the semiconductor layer and extends along the phase modulation layer in a state of being optically couplable with the phase modulation layer;
an n-type electrode connected to the n-type layer; and a p-type electrode connected to the p-type layer.

### [Supplementary Note 2]

The optical modulator according to supplementary note 1, wherein
a central axis in an extending direction of the phase modulation layer and a central axis in an extending direction of the optical coupling layer are shifted toward the n-type layer in a direction parallel to a plane of the substrate and perpendicular to the extending direction.

### [Supplementary Note 3]

The optical modulator according to supplementary note 1 or 2, wherein
the optical coupling layer is made of silicon or silicon nitride.

### [Supplementary Note 4]

The optical modulator according to any one of supplementary notes 1 to 3, wherein
a core of a passive optical waveguide optically connected to a rib-type optical waveguide by the semiconductor layer and the optical coupling layer has a width in which a main portion satisfies a single mode, and the width is made wider toward an input and output end of the rib-type optical waveguide.

Note that the present invention is not limited to the embodiment described above, and it is obvious that many modifications and combinations can be implemented by a person having ordinary knowledge in the art within the technical idea of the present invention.

### REFERENCE SIGNS LIST

101 Substrate
102 Lower cladding layer
103 Semiconductor layer
104 Optical coupling layer
105 n-type electrode
106 p-type electrode
107 Upper cladding layer
131 Phase modulation layer
132 n-type layer
133 p-type layer

1. An optical modulator comprising:
a cladding layer formed on a substrate;
a semiconductor layer formed of a group III-V compound semiconductor and disposed on the cladding layer;
a phase modulation layer extending in a predetermined direction in the semiconductor layer;
an n-type layer and a p-type layer formed in the semiconductor layer, the n-type layer and the p-type layer being in contact with the phase modulation layer with the phase modulation layer interposed therebetween in plan view;
an optical coupling layer that is stacked on the semiconductor layer and extends along the phase modulation layer in a state of being optically couplable with the phase modulation layer so as to form a rib-type optical waveguide together with the semiconductor layer;
an n-type electrode connected to the n-type layer; and
a p-type electrode connected to the p-type layer.

2. The optical modulator according to claim 1, wherein
a central axis in an extending direction of the phase modulation layer and a central axis in an extending direction of the optical coupling layer are shifted toward the n-type layer in a direction parallel to a plane of the substrate and perpendicular to the extending direction.

3. The optical modulator according to claim 1, wherein the optical coupling layer is made of silicon or silicon nitride.

4. The optical modulator according to claim 1, further comprising:
a passive optical waveguide optically connected to the rib-type optical waveguide, the passive optical waveguide including a main portion a core of which has a width that satisfies a single mode, and a taper portion the width of which is made wider from an end of the main portion toward the rib-type optical waveguide.

5. The optical modulator according to claim 2, wherein
the optical coupling layer is made of silicon or silicon nitride.
